(19) United States
(12) Patent Application Publication
(10) Pub. No.: US 2010/0155549 A1
(43) Pub. Date: Jun. 24, 2010

(54) Portable sports pod camera mount

(76) Inventor: Andy Robinson, Harrisburg, NC (US)

Correspondence Address: J.T. HOLLIN, ATTORNEY AT LAW, PC, 110 HABERSHAM DRIVE, SUITE 144, FAYETTEVILLE, GA, 30214, US

(21) Appl. No.: 12/317,343

(22) Filed: Dec. 22, 2008

(51) Int. Cl. F16M 11/24; G03B 17/56

(52) U.S. Cl. 248/183.1; 396/428

(57) ABSTRACT

Disclosed is a portable, segmented pole support system used to elevate a camera for recording or photographing action in the area above a volleyball net during game play. The device is capable of supporting an attached camera, video apparatus, monitor, or similar equipment from a secure fitting on a weighted base. Once secured to the pole, the equipment may then be incrementally elevated by extending different sections of the segmented pole to a height exceeding the reach of the device operator. As the court sites change during a multiple-court volleyball tournament, the device may be readily unlocked and compacted into an assembly with an attached carrying handle. The device, being easily portable, may be rapidly set up at each succeeding court location.

### CROSS-REFERENCES TO RELATED APPLICATIONS

### U.S. Patent Documents

| U.S. Patent #. | Date. | Classification | Inventor. |
|---|---|---|---|
| 4,051,525 | Sep. 27, 1977 | 358/106 | Kelly, D |
| 5,065,249 | Nov. 12, 1991 | 358/229 | Horn, D. |
| 5,786,854 | Jul. 28, 1998 | 348/373 | Slade, M., et al. |
| 6,007,259 | Dec. 28, 1999 | 396/428 | Mori, A., et al |
| 6,056,450 | May 02, 2000 | 396/428 | Walling, D. |
| 6,244,759 | Jun. 12, 2001 | 396/428 | Russo, R. |
| 6,769,824 | Aug. 03, 2004 | 396/419 | Nakatani, K. |
| 7,017,873 | Mar. 28, 2006 | 248/187.1 | Barth, R. |
| 7,344,320 | Mar. 18, 2008 | 396/419 | Barker, J. |

### U.S. Patent Application Publications

| Publication #. | Date Published. | Classification | Inventor. |
|---|---|---|---|
| 2006/0233544 | Oct. 19, 2006 | 396/428 | Coppola, R. |

### Foreign Patent Documents

| Patent #. | Date. | Classification | Inventor. |
|---|---|---|---|
| WO9747915 | Dec. 18, 1997 | G03B17/56 | Frost, R. |
| WO9941540 | Aug. 19, 1999 | F16M11/10 | Brown, G. |
| CA2518816 | Sep. 23, 2004 | G03B17/00 | Thomas, H. S. |
| WO2006079175 | Aug. 03, 2006 | G03B17/00 | Hirano, E |

### Other References

TacView pole camera, version 2600; TacView, Inc. 1300 S. Frazier, Suite Conroe, Tex. 77301
Lynx Camera Mount Pole; Gill Athletics: www.onlinesports.com/pages/I,GIA-E39909.html

### STATEMENT REGARDING FEDERALLY SPONSORED RESEARCH OR DEVELOPMENT

There is no federally sponsored research or development in conjunction with this invention.

### NAMES OF THE PARTIES TO A JOINT RESEARCH AGREEMENT

There is no joint research agreement associated with this inventive concept.

### BACKGROUND OF THE INVENTION

(1) Field of the Invention

This inventive concept pertains to support mechanisms intended to elevate or position video equipment at heights out of reach of the operator, yet still allow manual control of the equipment by the operator. The present concept stems from the need for a simple, compact, and rapidly deployable camera support system for capturing and/or recording net play activity at volleyball or basketball contests.

(2) Description of the Related Art

An earlier invention features a surveillance camera mounted upon a vertically adjustable hollow pole shaft. The pole contains an interior coaxial cable which runs from the camera atop the pole through the base of the pole, with the coaxial cable terminating in an electrical plug utilized to supply electrical power to the camera assembly (U.S. Pat. No. 4,051,525; Kelly).

In U.S. Pat. No. 5,065,249 (D. Horn, 1991) a portable support boom is disclosed which is capable of supporting both a video camera and a video monitor. The support boom is manually held in place and stabilized, while resting on the floor or ground, by a single cameraman. The pole has two sections connected by a collapsible joint at midpoint of the pole, enabling the pole to be folded into a more compact assembly.

A portable, self-contained telescoping camera tower system is depicted in U.S. Pat. No. 5,786,854 (Slade, 1998). An assembly of pulleys, bearing surfaces, and drive means serve to power the tower up or down. The preferred embodiment rests on a tripod, is portable, and may be operated by a single cameraman.

U.S. Pat. No. 6,056,450 (Walling, 2000) presents a device for elevating a camera above its operator. The device comprises either a flat, or wheeled support base and a rotatable telescoping pole. The top of the pole terminates in a platform to which a camera may be secured. Tilt of the camera is controlled by a cable which extends downward to a control arm on the pole. Panning of the camera is accomplished by manual rotation of the pole.

U.S. patent application No. 2006/0233544 (Coppola 2006) discloses a bipod platform system for a camera. Extending upward from a stable, flat platform, are two essentially parallel circular rods, both joined by a slidably-positioned horizontal cross member. The cross member has attachment points for mounting a camera, a mechanism for controlling the tilt of the camera, and may be positioned at varying heights, according to selection of the cameraman, by sliding the horizontal member up or down the two circular rods.

### BRIEF SUMMARY OF THE INVENTION

The inventive concept was spawned by the need arising at organized volleyball tournaments to elevate a video camera, from a very limited platform space. Thus, the camera may be positioned to film the area in the immediate vicinity of the volleyball net, including the flight of the ball and the hand strikes of the players. It is necessary to extend a video camera in excess of 10 feet vertically to obtain the desired field of view without obstruction from court dividers, net poles, or any type of moving object.

Most monopod camera supports in current use do not extend above 6′-0″ and are required to be held and/or steadied by the camera operator. Further, many monopods, if used with some type of leg attachment, do not support more than 5 or 6 pounds. Several types of base supports utilizing tripod extensions can hold greater weight, but take up significant ground or floor space. Camera support systems that can extend seven (7) feet or more have a large base area requirement, which is generally not available at volleyball tournaments. Thus, there is a need for a camera support system which has the following qualities: (1) takes up minimal space, (2) can elevate over 10 feet, (3) is sufficiently stable to support a camera weight approaching 10 pounds, (4) is not prone to tipping over or instability at its uppermost level and (5) may be compacted for rapid relocation.

The present invention features a vertically adjustable segmented pole, consisting of between two to four pole sections, with a means of locking into place each contiguous pole section as the length of the segmented pole is increased or decreased. The lower pole section is inserted into a relatively heavy, flat weighted base, which takes up minimal ground space. Different embodiments of the weighted base may be constructed with a geometrically-centered shaft for acceptance of a hollow lower pole section over the outer circumference of the shaft. Other embodiments of the weighted base may contain a sleeve integral to the geometric center of the weighted base, said sleeve designed to insertingly accept the lower pole section into the inner circumference of the sleeve. A mounting table is affixed to the uppermost section of the segmented pole, which mounting table is fitted with mechanisms to securely support a video camera.

### NUMERICAL INDEX TO COMPONENTS OF THE INVENTION

1. Weighted base
2. Circular sleeve
3. Segmented pole
4. Lower pole section
5. Intermediate pole section
6. Upper pole section
7. Compression collar
8. Pole threaded collar
9. Collar threaded portion
10. Button connector hole
11. Spring-loaded button connector
12. Locking pin
13. Retainer for locking pin
14. Retaining pin
15. Base flange
16. Lower pole retaining hole
17. Pole retaining channel
18. Sleeve retaining hole
19. Solid shaft
20. Shaft through-hole
21. Crescent retainer pin
22. Sleeve/shaft combination
23. Thumbscrew for attachment bolt
24. Adjustment lever
25. V-spring
26. Table tilt adjuster
27. Mounting table
28. Mounting table clamp
30.
31. Carry handle

### BRIEF DESCRIPTION OF THE VIEWS OF THE DRAWINGS

The section of this application containing descriptive drawings is submitted for a clearer understanding of the various functions of the inventive concept. These drawings are not necessarily illustrative of any limitations of the scope of the inventive concept, but show typical embodiments or components which are effective in accomplishing the objectives of the inventive concept.

FIG. 1 is a length-wise full view of the Portable Sports Pod Camera Mount, depicting a typical weighted base for support of the segmented pole.

FIG. 2 depicts a plan view of a weighted base constructed with an integral sleeve.

FIG. 2(a) presents an elevation view of the lower pole section inserted into the sleeve of the weighted base.

FIG. 2(b) illustrates the lower pole section inserted into the sleeve of the weighted base and held in place with a locking pin.

FIG. 3 is a plan view of the weighted base constructed with an integral support shaft.

FIG. 3(a) is a cutaway view of the weighted base and shaft, depicting a hollow lower pole section in place over the shaft of the weighted base.

FIG. 3(b) sets forth a view of the lower pole section inserted over the shaft of the weighted base and held in place by a retaining pin.

FIG. 4 is a plan view of a weighted base constructed with flanges and an integral shaft built inside of, and concentric with, the inner circumference of a sleeve.

FIG. 4(a) is an elevation cutaway view of the weighted base with the shaft/sleeve embodiment.

FIG. 4(b) presents a perspective of the weighted base, lower pole section inserted into the shaft/sleeve embodiment, and a crescent retaining pin.

FIG. 5 illustrates a cross-sectional view of a threaded collar, pending the joining of two pole sections.

FIG. 5(a) is a perspective view of the threaded collar of FIG. 5.

FIG. 5(b) is a view of the top of a pole segment which utilizes the threaded collar fastening mechanism.

FIG. 5(c) presents a perspective of FIG. 5(b).

FIG. 6 is a view of a lower pole section constructed with regularly-spaced connector holes.

FIG. 6(a) depicts the intermediate pole section showing the pop-out button integral to an internally mounted V-spring fastening mechanism just prior to the intermediate pole section joining with the lower pole section.

FIG. 6(b) shows the V-spring fastening mechanism.

FIG. 7 is a simplified view of the camera mounting table.

FIG. 8 illustrates the Portable Sports Pod Camera Mount in the compacted mode, including a carrying handle.

### DETAILED DESCRIPTION OF THE INVENTION

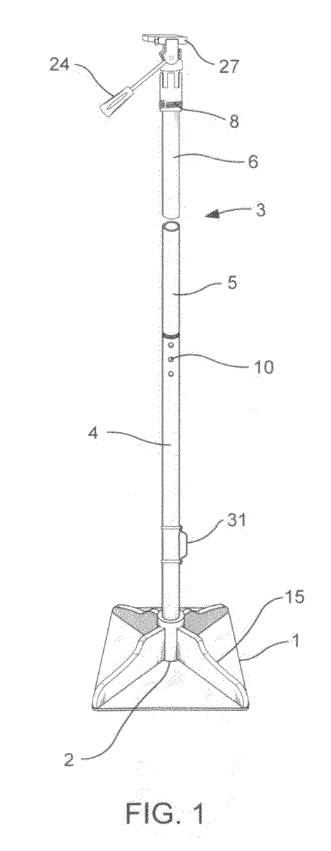

A description of the inventive concept is best understood in conjunction with reference to the accompanying drawings. The general descriptive flow shall begin at the base of the device and proceed upward. FIG. 1 presents a general view of the inventive concept, depicting a typical weighted base 1 upon which sits, in a vertical orientation relative to the weighted base 1, a segmented pole 3. The lower pole section 4 of the segmented pole 3 rests in a circular sleeve 2 as shown. An additional feature enhancing the portability of the inventive concept is a carry handle 31 shown attached to the lower pole section 4.

All pole sections are hollow and constructed of a light weight material such as aluminum, fiberglass, or PVC plastic. In FIG. 1 an intermediate pole section 5 is shown, as well as the upper pole section 6. The upper pole section 6 culminates at its top end with the attachment of a mounting table clamp 28 by which a mounting table 27 is affixed for the support of a still or video camera. The lower pole section 4 is constructed of the largest inner and outer diameter, in comparison with other pole sections. As the segmented pole 3 is observed from the weighted base 1 upward, each successively higher pole section has correspondingly smaller inner and outer diameters. This design feature permits the sequential collapsing of the upper pole section 6 into the next adjoining lower pole section.

After the completion of a filming or photographic session, the segmented pole 3 is compacted by releasing any pins 12, 14, locking buttons, and/or threaded collar 9 attachments binding the various pole sections and allowing the intermediate 5 and/or upper 6 pole sections to collapse one into the other, until the lower pole section 4 becomes the predominant containment structure of the device.

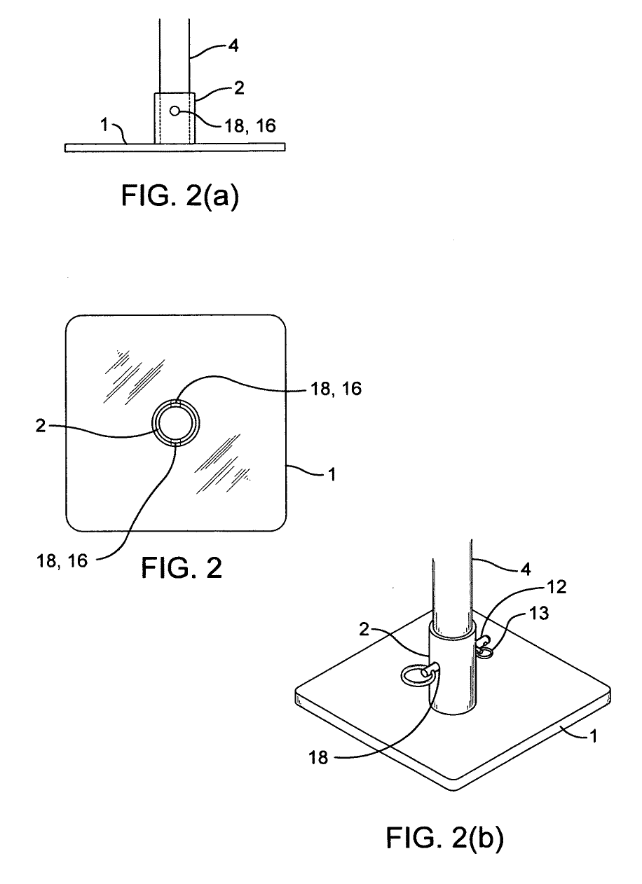

In referring to FIG. 2, the top view of a weighted base 1 is shown, including an integral, centrally-located circular sleeve 2. The circular sleeve 2 comprises an inner diameter sufficient to accommodate the insertion of the outside diameter of the lower pole section 4. Diametrically-opposed sleeve retaining holes 18 may be utilized, in conjunction with diametrically-opposed lower pole 4 retaining holes 16 drilled into the lower pole section 4, for the insertion of a retaining pin, crescent-shaped retaining pin 21, or other rounded linear fastener to further stabilize the lower pole section 4. FIG. 2(a) illustrates the manner in which the lower pole section 4 fits into the circular sleeve 2. FIG. 2(b) depicts the use of a locking pin 12 and a pin retainer 13 for securing the lower pole section 4 inside the circular sleeve 2.

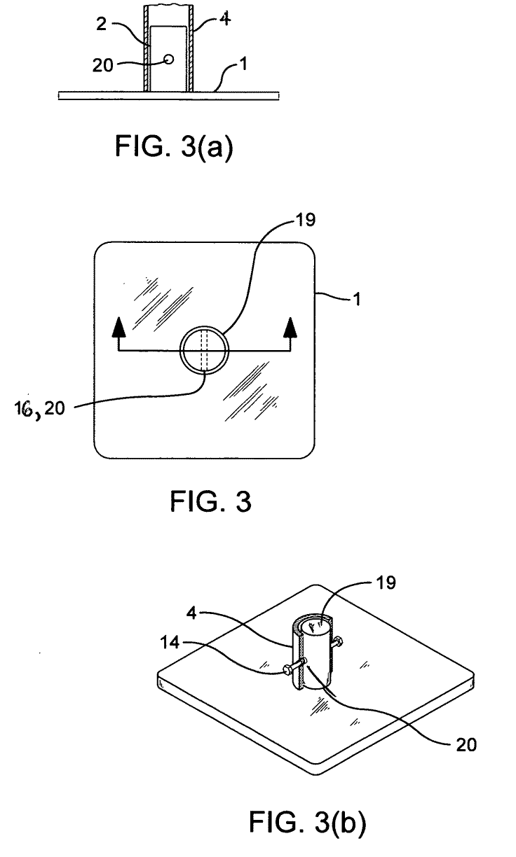

In viewing FIG. 3, there is presented the plan view of an embodiment of the weighted base 1 with an integral cylindrical solid shaft 19 projecting vertically upward. The solid shaft 19 may be constructed with a through-hole 20 for the accommodation of a retaining pin 14. The user, when setting up the device for operation, places the bottom end of the lower pole section 4 over the solid shaft 19, as is more clearly depicted in FIG. 3(a). If necessary, a retaining pin 12 or other suitable fastener may be inserted through the lower pole retaining holes 16, after aligning said holes with the shaft through-hole 20, as depicted in FIG. 3(b).

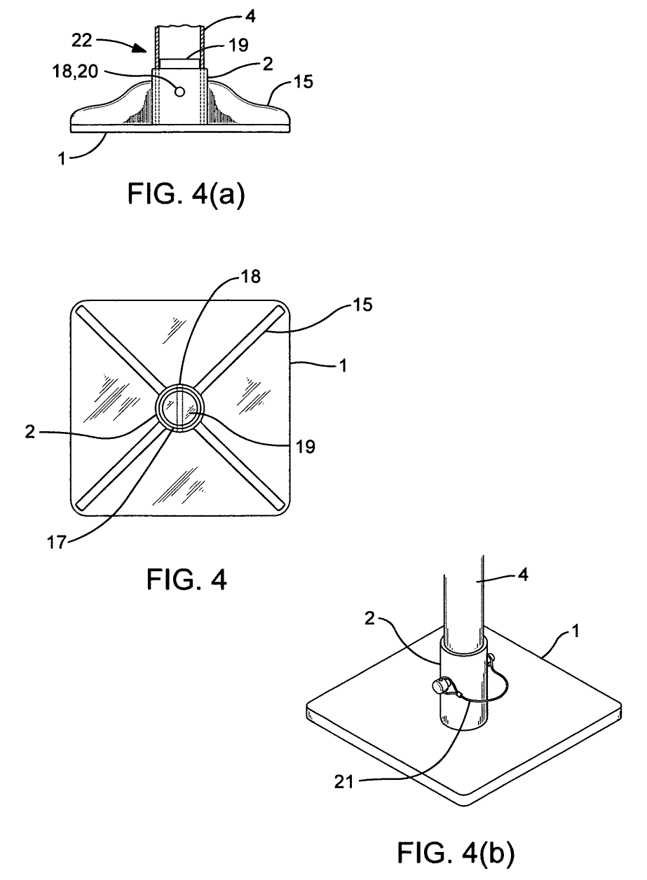

FIG. 4 and FIG. 4(a) present a plan view and an elevation view, respectively, of a different embodiment of the weighted base 1, comprising a concentric sleeve/shaft combination 22. Sufficient space is allowed between the outer surface of the solid shaft 19 and the inner surface of the circular sleeve 2 to form a circular pole retaining channel 17. This channel serves to permit the insertion of a corresponding length of the lower pole section 4. The weighted base also features four symmetrically constructed flanges 15 to further aid in the stability of the weighted base 1 and the rigidity of the sleeve/shaft combination 22.

Alternatively, the same sleeve/shaft combination 22 may be used in a planar weighted base 1 as shown in FIG. 4(b), along with the use of a crescent retaining pin 21, as shown in the figure. Any if the weighted bases shown throughout the figures and disclosures herein may be either planar shaped or contain flanges 15.

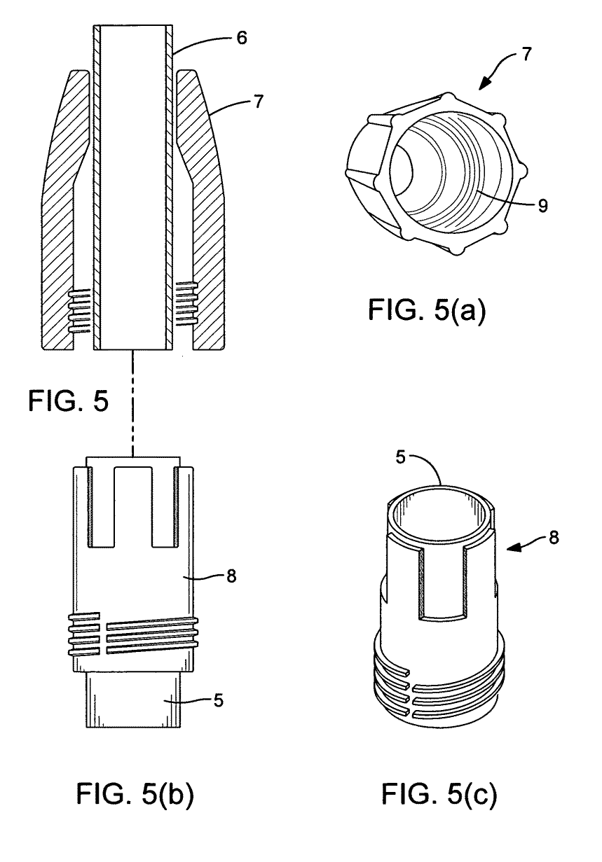

The contiguous pole sections featured in this inventive concept may be affixed one to the other in a variety of ways. As we view FIG. 5, there is presented a means of connecting pole sections featuring a compression collar 7 with an internal threaded portion 9, and an intermediate pole section 5 having, at its top end, an external pole threaded segment 8. In a vertically-oriented arrangement, the outer circumference of the bottom end of an upper pole section 6 fits within the unthreaded portion of the compression collar 7. The threaded segment 8 of the intermediate pole section 5 will accept the threaded portion 9 of the compression collar 7, along with the inner diameter of the bottom end of the upper pole section 6.

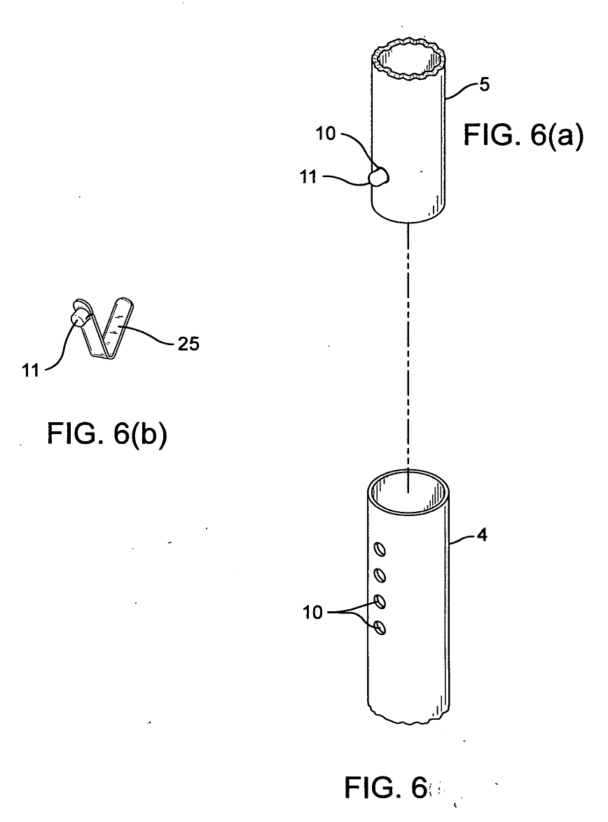

FIG. 6. presents an intermediate pole section 5 constructed with an internally mounted spring-loaded button connector 11. Upon depressing the spring-loaded button 11, the pole section 5 may be slidingly positioned inside the lower pole section 4, while maintaining the same pole-to-pole orientation. This constant orientation allows the spring-loaded button 11 to forcefully extend itself into one of the button connector holes 10 depicted on the lower pole section 4.

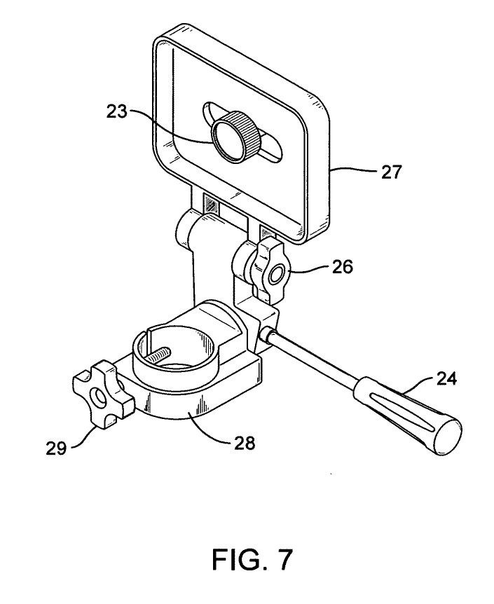

The sports pod camera has provision for a camera mounting table 27 attached to the uppermost pole section, as depicted in FIG. 7. A mounting table clamp 28 is fitted over the top pole section and secured by means of tightening of a four-arm handle 29. A thumbscrew 23, an integral part of a bolt, adjusts the bolt which itself fits into the threaded base of the vast majority of cameras. A table tilt adjuster 26 may be loosened to allow the base of the mounting table 27 to be adjusted in reference the level horizon.

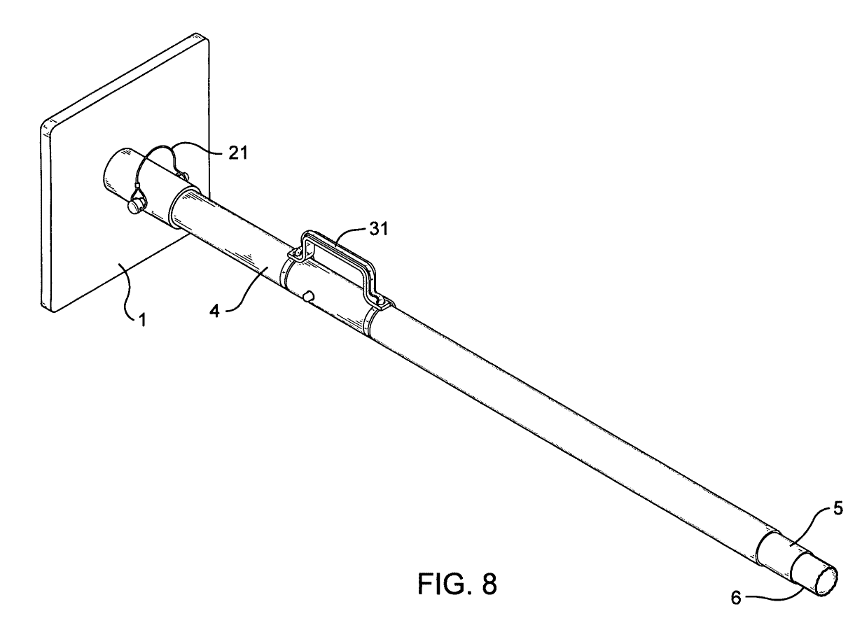

In FIG. 8 is shown the compacted mode of the device, illustrating the base 1, lower pole section 4, and carry handle 31. The upper 6 and intermediate 5 pole sections have been released from their attaching mechanisms and allowed to nestle within the lower pole 4.

The overall objective of this inventive concept is to facilitate the filming of game action in the immediate vicinity of a volleyball net. It should be kept in mind that space is severely restricted, particularly under circumstances where multiple courts are in simultaneous use during tournament play. With this in mind, a tri-pod leg arrangement for support of an elevated camera would be impractical, thus the need for a small footprint, weighted base support, as depicted in FIG. 1, (weighted base 1). It is important that the footprint of the base be minimal and that the base stay flat on the floor or ground, to avoid accidental jostling of the camera support or having a person trip over a tripod support leg.

The device is compact enough for travel by air or automobile. In its compacted mode, FIG. 8, the device is readily storable in the trunk of an automobile. Three pole sections can be compacted into a total length of four and one-half feet, with a total weight of approximately twenty-five pounds. When the device is fully extended and in-use, there is a total available height of approximately eleven feet, six inches.

It is anticipated that various embellishments, enhancements, and combinations may be suggested by the disclosures presented in this inventive concept, particularly by those persons skilled in the art. Nevertheless such enhancements and varied designs do not constitute a departure from the overall scope, spirit, and intent of the inventive concepts as set forth herein.

What is claimed is:

1. A support apparatus for elevating a still or video camera to a height appreciably above the top of the net of a volleyball court, the apparatus comprising:
a plurality of pole sections;
a means of connecting one pole section to another in a vertical orientation, such that the longitudinal axes of contiguous pole sections are coaxial;
a weighted base;
a means for retaining the bottom end of the lowest pole section within the horizontal geometric center of said weighted base;
a camera mounting table attached to the top of the uppermost pole section; and
an integral carrying handle.

2. The apparatus as in claim 1, wherein the means of connecting one pole section to another comprises a compression collar mechanism, further comprising a female internal threaded collar affixed to the bottom end of an upper pole section, and a male external threaded portion on the connecting end of a contiguous lower pole section.

3. The apparatus as in claim 1, wherein the means of connecting one pole section to another comprises an internal spring-loaded button in an upper pole section, which upper pole section fits within the inner circumference of a lower pole section having a plurality of regularly-spaced circular holes, any of said circular holes sized to accept the protruding spring-loaded button from the adjoining higher pole section.

4. The apparatus as in claim 1, further comprising a planar weighted base having, at its geometric horizontal center, a means for retaining the bottom end of the lowest pole section, said means selected from the group consisting of a vertical sleeve, a vertical shaft, or a combination of vertical sleeve and vertical shaft.

5. The apparatus in claim 1, further comprising a weighted base having vertically-oriented flanges and constructed with a means for retaining the bottom end of the lowest pole section, said means selected from the group consisting of a vertical sleeve, a vertical shaft, or a combination of vertical sleeve and vertical shaft.

6. A method for facilitating video filming of active play proximate the area above a volleyball net during actual play at a plurality of court locations, such method comprising the elevating of suitable video equipment to an appreciable height above the playing floor of a volleyball court by the use of a portable device, said device constructed by the steps comprising
acquiring a plurality of hollow, linear pole sections arranged in a vertically stacked manner whereby each lower pole section consists of an inner circumference greater than the outer diameter of the next successive higher pole section, thereby allowing the sequential extension of said pole sections;
arranging a means of fixedly connecting one pole section to another in a vertical orientation, such that the longitudinal axes of contiguous pole sections are coaxial;
obtaining a weighted base;
arranging a means for retaining the bottom end of the lowermost of said pole sections within the horizontal geometric center of said weighted base;
attaching a camera mounting table to the top of the uppermost pole section;
arranging a means by which suitable video or camera equipment may be secured to said mounting table;
arranging a means by which said pole sections may be disconnected and sequentially collapsed into an integral, portable unit; and
attaching a carry handle to the exterior surface of the lowermost of said pole sections.
